(19) United States
(12) Patent Application Publication
(10) Pub. No.: US 2006/0075389 A1
(43) Pub. Date: Apr. 6, 2006

(54) Device and method for API specification verification, program for executing the method, and storage medium for storing the program

(76) Inventors: Tomoaki Itoh, Tokyo (JP); Takao Yamaguchi, Osaka (JP); Takenobu Aoshima, Osaka (JP)

Correspondence Address: RATNERPRESTIA, P.O. BOX 980, VALLEY FORGE, PA, 19482, US

(21) Appl. No.: 11/232,636

(22) Filed: Sep. 22, 2005

(30) Foreign Application Priority Data
Oct. 1, 2004 (JP) 2004-290407

(51) Int. Cl. G06F 9/44

(52) U.S. Cl. 717/126

(57) ABSTRACT

An API specification verification device, an API specification verification method, a program for executing the method, and a storage medium for storing the program are disclosed herein, the API specification verification device and method enabling API which is not registered in a verification tool to be verified without modification to a program checking unit serving as the verification tool. The user inputs API to be verified and a specification of the API using an API specification input support unit. A program conversion unit converts a verification object program based on the input information into a form inputtable by the verification tool to output the converted program to the verification tool. The program checking unit verifies the converted program.

### FIELD OF THE INVENTION

This invention relates to a device and a method for software verification, which is used for verifying that a software meets specification of API in using the API, a program for executing the method, and a storage medium for storing the program.

### BACKGROUND OF THE INVENTION

An interface used for a software module to provide a function of the software module to another software module is called Application Program Interface (API). In the case of using a function of a software module by way of API, it is necessary for the software to use the API in accordance with a specification of the API.

For instance, in the case of C language standard library function, malloc ( ), calloc ( ), realloc ( ), and so forth have heretofore been offered as API dynamically securing a memory region to be used by an application program (hereinafter referred to as application) which is a software using the API. Also, free ( ) has been offered as API releasing the memory region.

The software using the API must meet the requirement, i.e. the specification of the API, of “the memory region secured by the memory securing API must be released by free ( )”. When the requirement is not met, memory resource is depleted since the secured memory region is not released, a failure of halt of the software can be caused in some cases due to the memory shortage.

Bounded Model Checking for ANSI-C (CBMC) has been used as a tool for verifying that the secured memory region is released without fail. The CBMC is a tool which uses model verification technologies to verify that the secured region is released without fail. For instance, the CBCM is disclosed in Clarke, Edmund, Kroening, Daniel and Lerda, Flavio, “A Tool for Checking ANSI-C Programs”, pp 168-176. Tools and Algorithms for the Construction and Analysis of Systems (TACAS 2004).

However, the conventional verification tool is useable only for verifying APIs registered therein, such as malloc ( ) and free ( ), and it is sometimes not able to verify API which is not registered in the tool, such as independent API. It is possible to use the conventional verification tool by modifying the verification tool so as to register API to be verified, but, when a source code of the verification tool has not been distributed or when it is difficult to understand an internal structure since the verification tool is a large scale software, the modification of the verification tool can be difficult. The verification tool may be a hardware or a software.

### SUMMARY OF THE INVENTION

This invention provides a device and a method for API specification verification, a program (referred to also as a method executing program) for executing the method, and a storage medium for storing the method executing program, enabling a user to input API and its specification to be verified without modifying a program checking unit serving as a verification tool and outputting a program (referred to also as an application program) to be verified after converting the application program into a form inputtable by the verification tool based on the input information so that the program checking unit verifies the converted application program.

### BRIEF DESCRIPTION OF THE DRAWINGS

FIG. 1 is a block diagram showing an API specification verification system including an API specification verification device according to one embodiment of this invention.

FIG. 2 is a diagram showing one example of GUI of an API specification input support unit according to the embodiment.

FIG. 3 is a flowchart showing an operation of the API specification verification system including the API specification verification device according to the embodiment.

FIG. 4 is a flowchart showing in detail an operation of program conversion performed by a program conversion unit according to the embodiment.

FIG. 5A is a diagram showing a conversion table according to the embodiment.

FIG. 5B is a diagram showing a verification object program before being subjected to the program conversion according to the embodiment.

FIG. 5C is a diagram showing the verification object program after being subjected to the program conversion according to the embodiment.

FIG. 5D is a diagram showing a line number table after completion of the program conversion processing according to the embodiment.

FIG. 6 is a flowchart showing in detail output conversion processing on program performed by an output conversion unit according to the embodiment.

FIG. 7A is a diagram showing an error message output before the conversion performed by the output conversion unit according to the embodiment.

FIG. 7B is a diagram showing an error message output after the conversion performed by the output conversion unit according to the embodiment.

### DETAILED DESCRIPTION OF THE INVENTION

An API specification verification device of this invention is prefixed to a program checking unit which verifies whether a usage of API to be used in a program meets a specification and outputs a result of the verification. The API specification verification device is provided with an API specification input support unit and a program conversion unit. The API specification input support unit is used for inputting API to be verified and a specification of the API. In the case where a verification object program is not in a form inputtable to the program checking unit, the program conversion unit converts the verification object program into the form inputtable by the program checking unit using the API and the specification of the API input from the API specification input support unit to output the thus converted program to the program checking unit.

Therefore, it is possible to verify whether API which has not been registered in a model checking tool meets a specification without modifying the program checking unit which is the existing model checking tool.

The API specification input support unit of the API specification verification device of this invention registers an API formation function to be verified, a release function, and a variable representing a resource to support the input of the specification to be verified.

The API specification input support unit makes it easier to input the API specification.

Also, the API specification verification device of this invention may have an output conversion unit which is postfixed to the program checking unit. The program conversion unit may record the converted portion of the program. The output conversion unit extracts an error message corresponding to the converted portion when the verification result is an error to output an error message corresponding to the API input by the API specification input support unit.

Therefore, it is unnecessary for a user to know which program has been converted by the program conversion unit, thereby improving convenience for the user.

The API specification input support unit of the API specification verification device of this invention inputs a value representing a resource used by the API to be verified.

Thus, it is possible to specify a return value or with what number of arguments a resource is to be secured by using the API which is returned. Further, it is possible to designate with which one of the arguments the API using the resource is handed the value representing the resource, thereby enabling to input the API specification flexibly.

An API specification verification method of this invention includes an API specification input support step and a program conversion step, which are performed in advance of a program checking step for verifying whether a usage of API to be used in a program meets a specification to output a result of the verification. The API specification input support step is a step for inputting the API to be verified and the specification of the API. The program conversion step is a step for converting, in the case where a verification object program is not in a form inputtable to the program checking step, the verification object program into the form inputtable by the program checking step using the input API and the input specification to output the converted program to the program checking step.

A method executing program of this invention allows a computer to execute the API specification verification method. A storage medium of this invention stores the method executing program.

Hereinafter, an API specification verification system including an API specification verification device according to one embodiment of this invention will be described using the drawings.

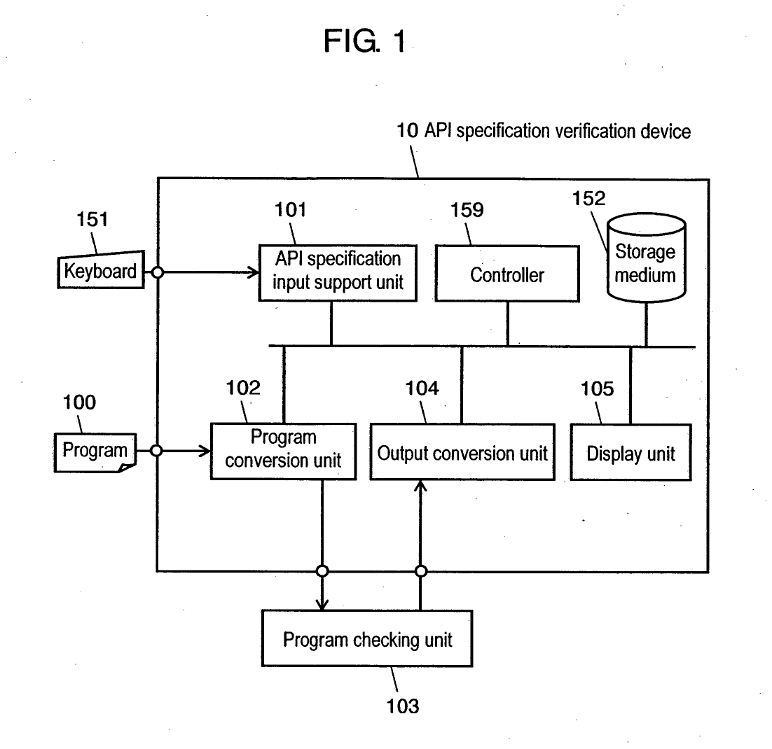

A constitution of the API specification verification system including the API specification verification device according to the embodiment will be described using FIG. 1. FIG. 1 is a block diagram showing the API specification verification system including the API specification verification device of this invention.

The API specification verification system is provided with API specification verification device 10, program checking unit 103, and keyboard 151. API specification verification device 10 is provided with API specification input support unit 101, program conversion unit 102, output conversion unit 104, display unit 105, storage medium 152 storing a method executing program, which is a program for allowing operation of API specification verification device 10, and control unit 159 for controlling the above units of API specification verification device 10. Program 100, which is an application program, is a verification object program. Operation of API specification verification device 10 is based on the program stored in storage medium 152 and controlled by control unit 159.

API specification input support unit 101 is Graphic User Interface (GUI) which enables a user to input an API specification by the use of keyboard 151. By the use of API specification input support unit 101, the API is classified into a secure (formation) system function, a release system function, and an access system function to be registered.

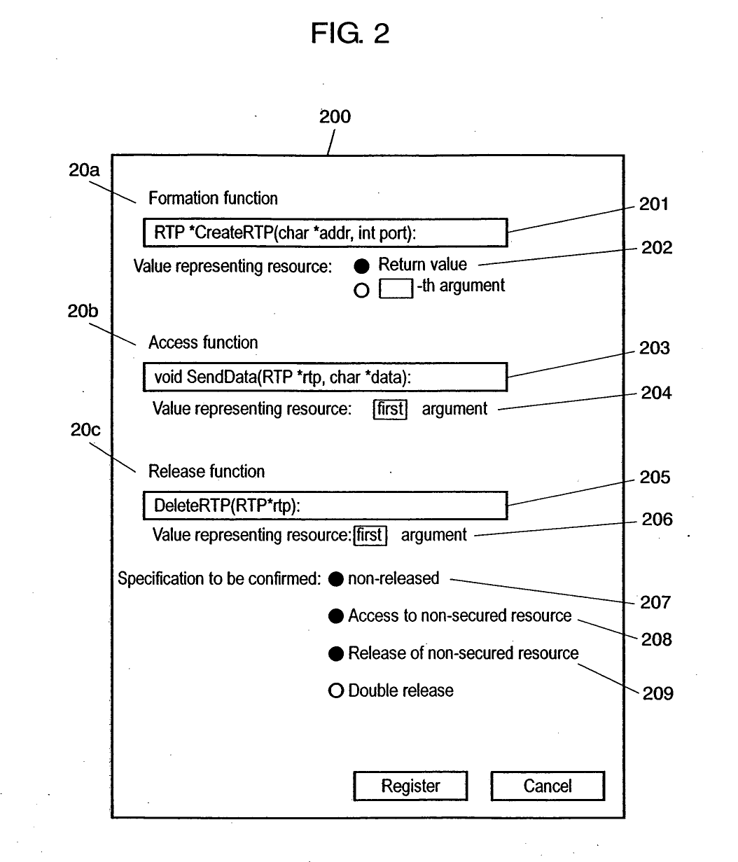

Details of the API registration using API specification input support unit 101 will be described later in this specification using FIG. 2.

API specification input support unit 101 passes the registered API information to program conversion unit 102. Hereinafter, the API input by API specification input support unit will be referred to as independent API. In turn, API which can be verified by program checking unit 103 serving as an existing model checking tool such as a memory secure function will be referred to as registered API.

Program conversion unit 102 converts input program 100 into a program which can be verified by program checking unit 103 based on the information of the independent API received from API specification input support unit 101. More specifically, program conversion unit 012 searches program 100 based on an identifier of the independent API to convert a statement for calling up the independent API into a statement for calling up both of the independent API and the registered API.

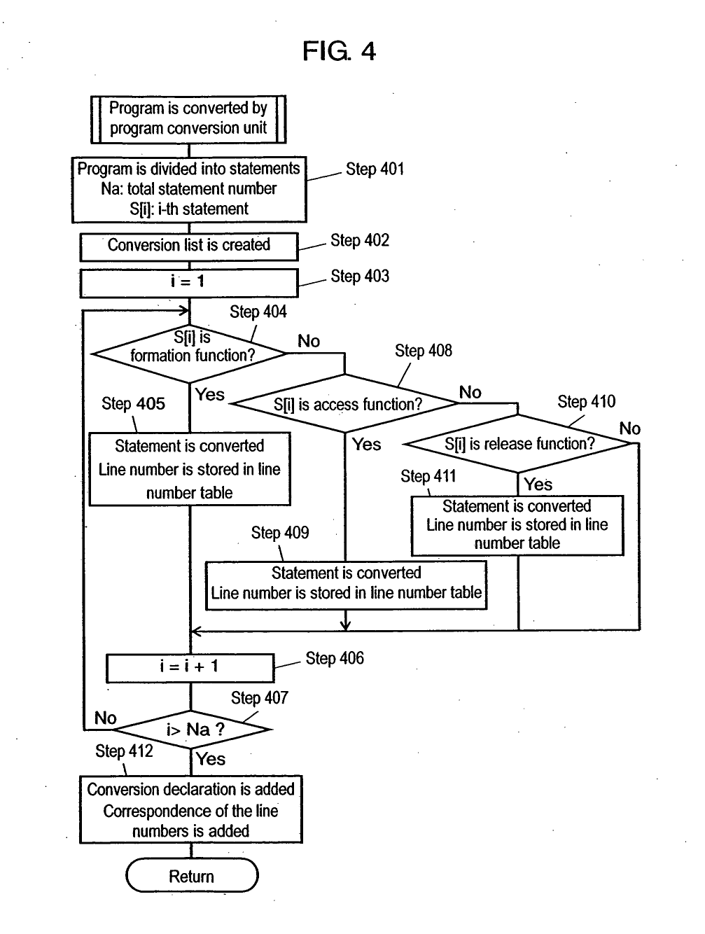

Details of the program conversion method will be described later in this specification using FIG. 4.

Program conversion unit 102 records a line number of the converted portion of the program on a line number table. Program conversion unit 102 outputs the converted program to program checking unit 103.

Program checking unit 103 is an existing verification tool. Program checking unit 103 may be a verification tool based on model checking technologies, such as CBMC, for example. Alternatively, program checking unit 103 may be a verification tool based on static analysis technologies, such as SPLINT (Secure Programming Lint). Program checking unit 103 outputs an error to output conversion unit 104 when the usage of the API of the program sent from program conversion unit 102 does not meet the specification. The error output is a set of a line number containing the error and an error message indicating type of the error.

Output conversion unit 104 monitors the output from the verification tool. In the case where an error is output from program checking unit 103, output conversion unit 104 compares the line number recorded on the line number table in program conversion unit 102 with a line number contained in the error output. In the case where the line numbers are identical to each other, output conversion unit 104 converts an error message of the verification tool into an error message indicating that the usage of the API contains the error to output the error message to display unit 105.

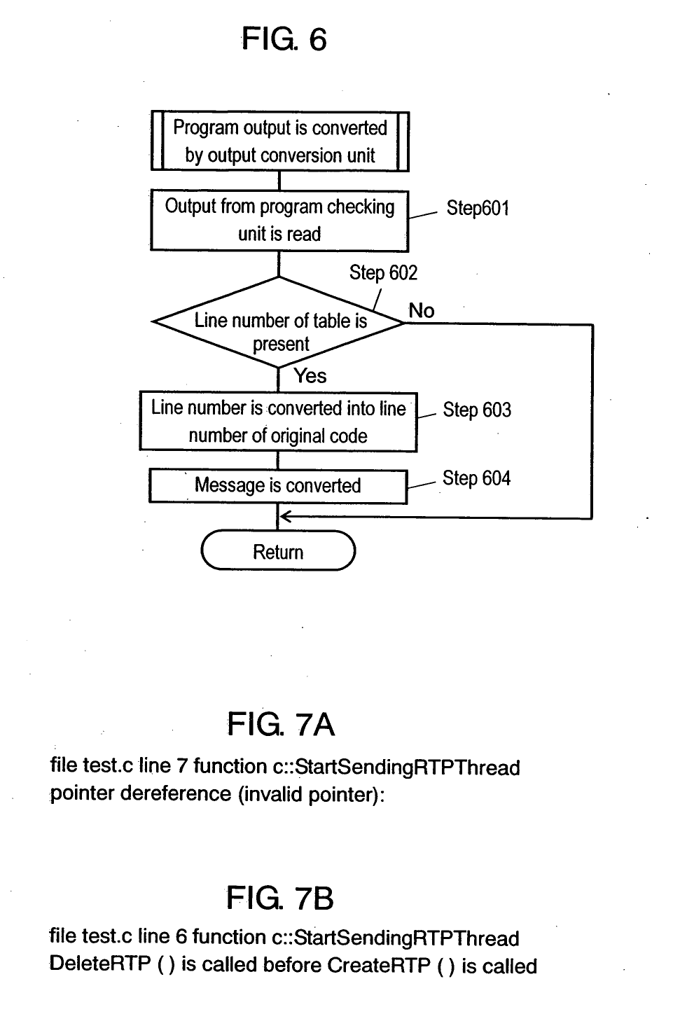

Details of the error message conversion method will be described later in this specification using FIG. 6.

Display unit 105 outputs the error message converted by output conversion unit 104.

Next, GUI of API specification input support unit 101 according to this embodiment will be described using FIG. 2. FIG. 2 is a diagram showing one example of GUI of API specification input support unit 101 according to this embodiment.

GUI 200 of API specification input support unit 101 of this embodiment registers API by classifying the API into a formation function, an access function, and a release function as indicated by 20A to 20C in FIG. 2.

Formation function 20A is an API for securing a resource when using the API. Access function 20B is API for accessing the secured resource using the formation function. Release function 20C is a function for releasing the resource secured by the formation function.

For instance, there is the case where a network includes RTP (Realtime Transport Protocol: a protocol for stream transmission of AV data) and API for sending/receiving a packet, having the following specification.

RTP *CreateRTP (char *addr, int port): resource for sending/receiving an RTP packet is secured and the secured resource is represented by the use of a return value of the resource. A destination address and a port number of the RTP packet are specified by addr and port.

An RTP packet is transmitted by the use of a resource represented by void SendData (RTP *rtp, char *data):rtp. The packet should not be sent when no resource is secured therefore.

A resource represented by DeleteRTP (RTP *rtp):rtp is released. The secured resource must be released without fail. Any non-secured resource should not be released.

Based on the above-described API specification, the formation function is CreateRTP ( ), and this formation function is registered in a column of formation function 201 of GUI 200. Also, since the value representing the resource is set to the return value, the value representing the resource is set to return value 202 of GUI 200.

The access function is SendData ( ), and this access function is registered in a column of access function 203 of GUI 200. Also, since the value representing the resource used in SendData ( ) is handed by the first argument, the value representing the resource is set to first argument 204 of GUI 200.

The release function is DeleteRTP ( ), and this release function is registered in a column of release function 205 of GUI 200. Also, since the value representing the resource to be released is handed by the first argument, the value representing the resource is set to first argument 206 of GUI 200.

Since it is prohibited to call up SendData ( ) and DeleteRTP before securing resources, access 208 to non-secured resource of specification to be confirmed and release 209 of non-secured resource are set to ON. Also, since it is necessary to release the secured resource without fail, non-release 207 of specification to be confirmed is set to ON.

The API is classified into the information relating to formation function, the information relating to access function, and the information relating to release function by the use of GUI 200 as described above to be registered. Thus, API specification input is made easier. Also, by the use of GUI 200, the return value or the number of arguments to be used for returning the resource secured by API is specified. Further, by the use of GUI 200, the argument to be used by API using the resource for receiving the value representing the resource is specified. Therefore, it is possible to perform the API specification input flexibly.

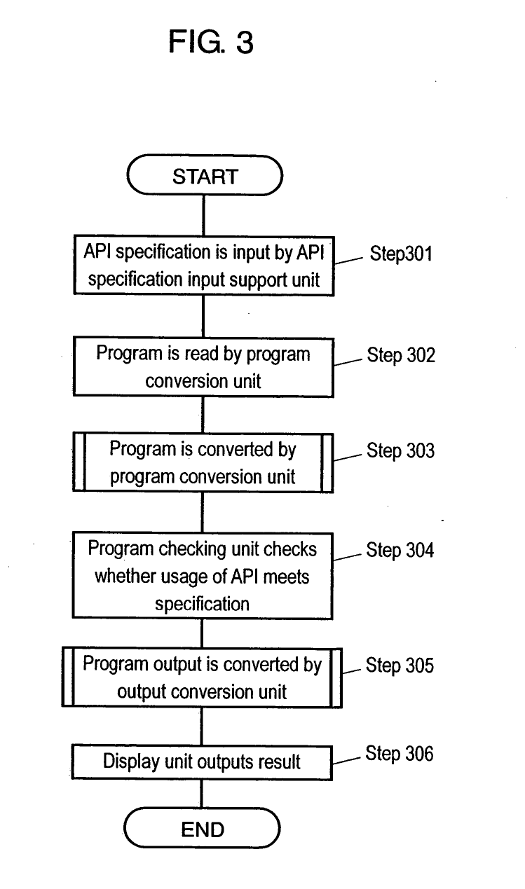

Hereinafter, operation of the API specification verification system including the API specification verification device according to this embodiment will be described using FIG. 3. FIG. 3 is a flowchart showing the operation of the API specification verification system including the API specification verification device according to this embodiment.

The API specification input by the user using keyboard 151 is imported into device 10 via API specification input support unit 101 and then sent to program conversion unit 102 (STEP 301).

Program conversion unit 102 reads program 100 which is the object of verification (STEP 302), and the program is converted based on the specification input in API specification input support unit 101. Program conversion unit 102 records a line number of a line changed by the conversion on the line number table (STEP 303). Then, program conversion unit 102 outputs the converted program to program checking unit 103.

Program checking unit 103 checks the program input from program conversion unit 102 (STEP 304). Program checking unit 103 then outputs a result of the program checking to output conversion unit 104.

Output conversion unit 104 searches a line number corresponding to the line number stored in the line number table in the output and then converts an error output to output the error to display unit 105 (STEP 305).

Thus, program conversion unit 102 records the converted portion of the program, and output conversion unit 104 extracts an error message corresponding to the recorded converted portion when the verification result contains an error. Output conversion unit 104 outputting the error message corresponding to the API input in API specification input support unit 101 is further provided. Thus, it is unnecessary for the user to know the program converted by program conversion unit 102, thereby further improving convenience for the user.

Lastly, display unit 105 displays the output obtained from output conversion unit 104 to terminate the processing (STEP 306).

As described in the foregoing, the API specification verification system including the API specification verification device verifies whether program 100 meets the specification in accordance with the control by control unit 159 based on the program stored in storage medium 152.

Hereinafter, operation (STEP 303) of the program conversion of program conversion unit 102 shown in FIG. 3 will be described using FIG. 4. FIG. 4 is a flowchart showing in detail the operation (STEP 303) of the program conversion of program conversion unit 102.

Program conversion unit 102 interprets program 100 to segment program 100 by a statement unit (STEP 401). In the following description, all statement numbers are represented by Na, and an i-th statement is represented by S[i].

Program conversion unit 102 extracts a variable declared as a type for storing a value representing a resource among declared variables i and creates a conversion table (list) to be recorded (STEP 402).

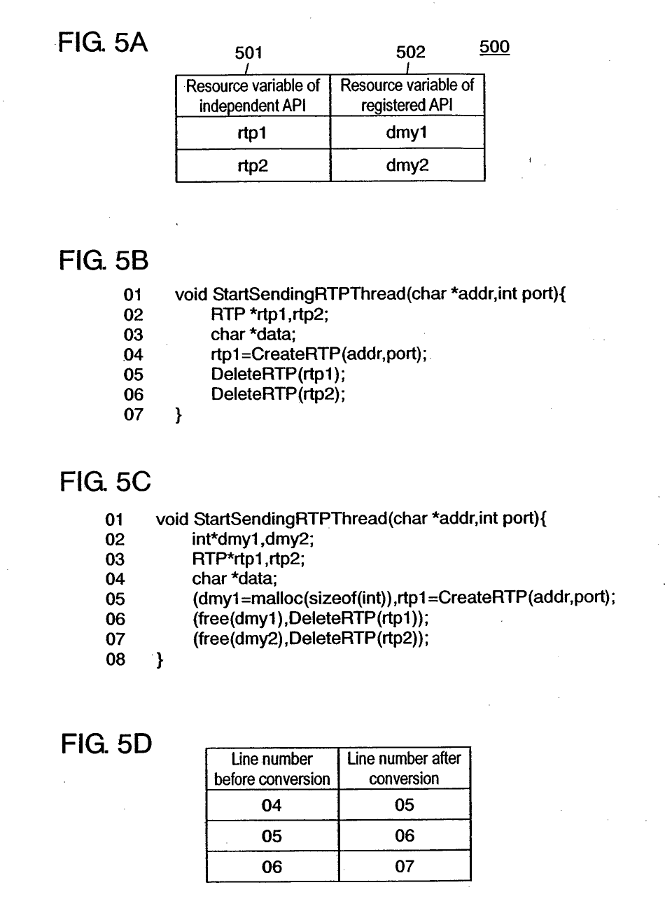

The conversion table is shown in FIG. 5A. As shown in FIG. 5A, conversion table 500 is used for confirming a correspondence of a resource variable of independent API 501 to a resource variable of registered API 502.

Program conversion unit 102 refers to conversion table 500 based on the resource variable of independent API to find the corresponding resource variable of registered API.

Program conversion unit 102 set variable i to 1 (STEP 403) and then starts to check the statements from the first statement.

Program conversion unit 102 checks whether the first statement is the one calling up the formation function of API (independent API) input to API specification input support unit 101 (STEP 404).

When the statement checked in STEP 404 is the one calling up the formation function, the statement is converted into a statement for calling up both of a formation function of API (registered API) verifiable by program checking unit 103 and the formation function of independent API (STEP 405). Program conversion unit 102 decides a name of a variable (resource variable) for storing a resource value returned from the formation function of registered API in the following manner.

Program conversion unit 102 fetches the resource variable of the formation function of independent API of the statement to refer to conversion table 500. Program conversion unit 102 uses the variable when a resource variable of corresponding registered API has been registered. In the case where the resource variable of the corresponding registered API has not been registered, program conversion unit 102 generates a unique variable name to register the variable name as the resource variable of registered API and generates a statement using the variable.

Program conversion unit 102 records a corresponding line number on the line number table (STEP 405) and proceeds to STEP 407 after incrementing the variable i by 1 (STEP 406).

Program conversion unit 102 then checks whether all the statements have been checked, i.e., whether the variable i has exceeded the number of all statements Na (STEP 407). When the checking on all statements has not been completed yet, the process returns to STEP 404.

In turn, when the statement checked in STEP 404 is not the one calling up the formation function, program conversion unit 102 checks whether the statement is the one calling up the access function (STEP 408).

When the statement checked in STEP 408 is the one calling up the access function, the statement is converted into the statement for calling up the access function of registered API and the access function of independent API. At the time of the conversion, program conversion unit 102 decides a resource variable to be handed to the access function of registered API in the same manner as the method described in conjunction with the formation function.

Program conversion unit 102 records the corresponding line number on the line number table (STEP 409.) to proceed to STEP 406.

In turn, when the statement checked in STEP 408 is not the one calling up the access function, program conversion unit 102 checks whether the statement is the one calling up the resource function (STEP 410).

When the statement checked in STEP 410 is the one calling up the release function, the statement is converted into a statement for calling up both of the release function of registered API and the release function of independent API. At the time of the conversion, program conversion unit 102 decides a resource variable to be handed to the release function of registered API in the same manner as the processing described in the case of the conversion of formation function. Program conversion unit 102 records a corresponding line number on the line number table (STEP 411) to proceed to STEP 406.

When the statement checked in STEP 410 is not the one calling up the release function, the process proceeds to STEP 406.

Program conversion unit 102 judges whether checking on all the statements has been completed (STEP 407). When checking on all statements has been completed, a declaration of the resource variable in the conversion table is added to the conversion result. Further, program conversion unit 102 registers a correspondence of a line number of the converted program to a line number of the program before the conversion to register the correspondence in the line number table (STEP 412) and then outputs the conversion result to terminate the processing.

FIGS. 5A to 5D are diagrams showing results obtained by applying the program conversion of FIG. 3 to a verification object program. FIG. 5A is a diagram showing the conversion table in the program conversion processing of FIG. 3. FIG. 5B is a diagram showing the verification object program before the program conversion. FIG. 5C is the verification object program after the conversion. At a portion to be converted, the verification object program after conversion preferably has a form not to delete and rewrite source code before conversion but to write thr result of conversion additionally.

For example, according to FIGS. 5A-5D, “rtp1=CreateRTP(addr, port)”,which is a portion to be converted, in the 4th line of FIG. 5B is not deleted after convertion, and as shown in the 5th line of FIG. 5C, “dmy1=malloc(sizeof(int))” is written additionally. The 5th and 6th lines of FIG. 5B are the same forms discussed above. Such set of the programs enables to avoid changing action, which is caused by changing an executed result of data from before conversion at the verification object program after conversion, in the following processes.

For example, in FIGS. 5B, case where “trp1=NULL;” is inserted between the 3rd line and the 4th line, and “if (rtpl=NULL) return;” is inserted between the 4th line and the 5th line is considered. In this case, at the conversion process, when “dmy1=malloc(sizeof(int))” is not written additionally, but “rtp1=CreateRTP(addr, port)” is deleted and “dmy1=malloc(sizeof(int))” is rewritten, inserted IF statement described above always becomes truth, so that action of the program changes between before and after conversion of the program.

On the other hand, according to the present embodiment, at the conversion process, when “dmy1=malloc(sizeof(int))” is written additionally, changing of action discussed above is not generated because of the program conversion, thereby avoiding change of action caused by conversion in the following processes. FIG. 5D is a diagram showing the line number table after the program conversion of FIG. 3.

In this example, a formation function is included on the fourth line of FIG. 5B, and a release function is included in each of the fifth and the sixth line of FIG. 5B. When the processing described using FIG. 4 is applied, the formation function on the fourth line of FIG. 5B and the release functions on fifth and sixth lines are objects in the conversion processing.

Hereinafter, the processing will be described step by step. Since there is a resource variable in the second line of FIG. 5B, program conversion unit 102 creates a conversion table based on the resource variable. At this time point, a column of a resource variable of corresponding registered API in conversion table 500 shown in FIG. 5A is blank. Then, program conversion unit 102 converts the formation function on the fourth line of FIG. 5B into that of the fifth line of FIG. 5C. In this case, program conversion unit 102 refers to conversion table 500. Since the resource variable of registered API corresponding to rtpl has not been registered, a unique variable dmyl is registered to output dmyl as a resource variable of the formation function of registered API as shown in the fifth line of FIG. 5C.

Then, program conversion unit 102 converts the fifth line of FIG. 5B into the sixth line of FIG. 5C. In this case, since program conversion unit 102 confirms that the resource variable of registered API corresponding to rtpl is dmyl by referring to conversion table 500, program conversion unit 102 generates the sixth line FIG. 5C using dmyl.

Program conversion unit 102 then converts the sixth line of FIG. 5B into the seventh line of FIG. 5C. In this case, program conversion unit 102 refers to conversion table 500. Since the resource variable of registered API corresponding to rtp2 has not been registered, a unique variable dmy2 is registered to output dmy2 as the resource variable of the formation function of registered API as shown in the seventh line of FIG. 5C.

After completion of checking on all the statements, program conversion unit 102 outputs variable declarations of all the resource variables of registered API in conversion table 500 to the second line of FIG. 5C to terminate the processing.

Foregoing is the program conversion performed by program conversion unit 102.

Hereinafter, the output conversion processing (STEP 305 of FIG. 3) of a program performed by output conversion unit 104 will be described in detail using FIG. 6. FIG. 6 is a flowchart showing in detail the output conversion processing of a program performed by output conversion unit 104.

Output conversion unit 104 reads the error output sent from program checking unit 103 (STEP 601) to judge whether the line number in the column of the converted number in the line number table is an error output (STEP 602).

In the case where the line number in the converted number column of the line number table is an error output in STEP 602, output conversion unit 104 extracts an error message to change the line number to the line number of the program before conversion (STEP 603). Output conversion unit 104 then converts the error comment (message) (STEP 604) to terminate the processing.

In the case where the line number in the converted number column of the line number table is not an error output in STEP 602, output conversion unit 104 terminates the processing without conversion.

Examples of error messages output by output conversion unit 104 are shown in FIGS. 7A and 7B. Shown in FIG. 7A is the error message output before conversion, and shown in FIG. 7B is the error message output after conversion.

As is apparent from FIGS. 7A and 7B, the line number has been changed, and the comment corresponds to the error.

Foregoing is the output conversion processing performed by output conversion unit 104 on the program sent from the program checking unit.

As described above, according to this embodiment, the user inputs API and specification of the API that the user desires to verify, and the verification object program is converted into a form inputtable to program checking unit 103 based on the input information. Accordingly, it is possible to verify API which is not registered in a verification tool without modifying program checking unit 103 which is a conventional verification tool. Also, since it is possible to perform the API specification input flexibly, it is possible for the user to verify whether the usage of API meets the specification without any burden being imposed on the user.

The API specification verification device, the API specification verification method, the program for executing the method, and the storage medium for storing the program according to this invention are used for verifying that a software meets a specification of API in using the API.

Though the API specification verification device and the program checking unit which is the conventional verification tool are described as separate units in this embodiment, this invention is not limited to the embodiment, and the units are integrated with each other as one device. Also, one computer may execute the API specification verification operation and the verification tool operation as a software tool.

What is claimed is:

1. An API specification verification method for verifying whether a usage of API to be used in a program meets a specification to output a verification result, said method comprising:
an API specification input support step for inputting the API and a specification of the API and
a program conversion step for converting, in the case where a verification object program is not in a form inputtable in a program checking step, the verification object program into the form inputtable in the program checking step by the use of the input API and the input specification to output the converted program to the program checking step.

2. The API specification verification method of claim 1, wherein the API specification input support step comprises registering a formation function, a release function, and a variable representing a resource of the API to support the input operation of the specification to be verified.

3. The API specification verification method of claim 2, wherein
the program conversion step comprises recording a converted portion of the program,
the method further comprising
an output conversion step for extracting an error message corresponding to the converted portion to output an error message corresponding to the API input in the API specification input support step when the verification result is an error, the output conversion step being performed after the program checking step.

4. A method executing program for allowing a computer to execute an API specification verification method, wherein
the method comprises, in advance of a program checking step for verifying whether a usage of API used in an application program meets a specification to output a verification result,
an API specification input support step for inputting the API and a specification of the API and
a program conversion step for converting, in the case where an verification object application program is not in a form input table in the program checking step, the verification object application program into the form inputtable in the program checking step by the use of the input API and the input specification to output the converted application program to the program checking step.

5. The method executing program of claim 4, wherein the API specification input support step comprises registering a formation function, a release function, and a variable representing a resource of the API to support the input operation of the specification to be verified.

6. The method executing program of claim 5, wherein
the program conversion step comprises recording a converted portion of the application program,
the program further comprising
an output conversion step for extracting an error message corresponding to the converted portion to output an error message corresponding to the API input in the API specification input support step when the verification result is an error, the output conversion step being performed after the program checking step.

7. A storage medium for storing a method executing program for allowing a computer to execute an API specification verification method, wherein
the method comprises, in advance of a program checking step for verifying whether a usage of API used in an application program meets a specification to output a verification result,
an API specification input support step for inputting the API and a specification of the API and
a program conversion step for converting, in the case where an verification object application. program is not in a form inputtable in the program checking step, the verification object application program into the form inputtable in the program checking step by the use of the input API and the input specification to output the converted application program to the program checking step.

8. The storage medium of claim 7, wherein
the API specification input support step comprises registering a formation function, a release function, and a variable representing a resource of the API to support the input operation of the specification to be verified.

9. The storage medium of claim 8, wherein
the program conversion step comprises recording a converted portion of the application program,
the storage medium further comprising
an output conversion step for extracting an error message corresponding to the converted portion when the verification result is an error to output an error message corresponding to the API input in the API specification input support step, the output conversion step being performed after the program checking step.

10. An API specification verification device comprising, in such a fashion as to be performed in advance of a program checking unit for verifying whether a usage of API to be used in a program meets a specification to output a verification result,
an API specification input support unit for inputting the API and a specification of the API; and
a program conversion unit for converting, in the case where a verification object program is not in a form inputtable by the program checking unit, the verification object program into the form inputtable to the program checking unit by the use of the input API and the input specification to output the converted program to the program checking unit.

11. The API specification verification device of claim 10, wherein
the API specification input support unit registers a formation function, a release function, and a variable representing a resource of the API to support the input operation of the specification to be verified.

12. The API specification verification device of claim 11, wherein
the program conversion unit records a converted portion of the application program,
the device further comprising
an output conversion unit for extracting an error message corresponding to the converted portion to output an error message corresponding to the API input in the API specification input support unit when the verification result is an error, the output conversion unit being postfixed to the program checking unit.
